(19) United States
(12) Patent Application Publication
(10) Pub. No.: US 2013/0120325 A1
(43) Pub. Date: May 16, 2013

(54) SOURCE DRIVER

(71) Applicant: Chia-Lung Chen, Tainan City (TW)

(72) Inventor: Chia-Lung Chen, Tainan City (TW)

(73) Assignee: HIMAX TECHNOLOGIES LIMITED, Tainan City (TW)

(21) Appl. No.: 13/293,606

(22) Filed: Nov. 10, 2011

(51) Int. Cl. G09G 3/36; G06F 3/038

(52) U.S. Cl. 345/204; 345/98

(57) ABSTRACT

A source driver includes a detector, a plurality of buffers and a plurality of output channels. The detector switches a disable signal to an enable signal according to a start pulse, wherein the source driver prepares to output display data according to the start pulse. The buffers are electrically connected to the detector. Furthermore, each of the buffers stops operating according to the disable signal and starts operating according to the enable signal. The output channels are electrically connected to output ends of the buffers, and the source driver transmits signals outputted by the buffers through the output channels.

### BACKGROUND OF THE INVENTION

1. Field of the Invention

The present invention relates to a source driver, and more particularly to a source driver using a start pulse to control an internal buffer.

2. Description of Related Art

A source driver is an indispensable component in a Liquid Crystal Display (LCD) device, and the LCD device may control a source driver with reference to a power-on sequence in FIG. 1. Wherein, VCC in FIG. 1 refers to an analog power voltage, VDD refers to a digital power voltage, TP refers to a start pulse, I1 refers to an operating current of the source driver and DS1 refers to an output signal of the source driver. As shown in FIG. 1, the LCD device first provides the digital power voltage VDD required by an internal digital circuit thereof and then provides the analog power voltage VCC required by an analog circuit thereof (for example, a source driver).

When the analog power voltage VCC is continuously provided for a period, the LCD device generates a start pulse TP to the source driver for preparing to output display data. Now, the source driver operates normally and maintains at a normal operating current I12. Furthermore, in the early stage of operation, the timing controller will not transmit the display data to the source driver. Therefore, in a display period BC12, the source driver will not generate any output signal. When the digital power voltage VDD, the analog power voltage VCC and the start pulse TP are ready, i.e. in a display period BC13, the timing controller transmits the display data to the source driver, so that the LCD device generates a corresponding display image.

However, in the period when the analog power voltage VCC continuously rises, that is in a display period BC11, the output signal of the source driver is unknown, so that the LCD device may generate a random noise, thereby influencing the display quality. Furthermore, in the period when the analog power voltage VCC continuously rises, the source driver may generate a peak current I11.

### SUMMARY OF THE INVENTION

The present invention provides a source driver, which enables an internal buffer according to a start pulse, thereby preventing a peak current generated in a period when an analog power voltage continuously rises.

The present invention provides a source driver, which determines whether or not to enable the internal buffer according to a detection result of the start pulse, thereby preventing generating the peak current.

The present invention provides a source driver, which includes a detector, a plurality of buffers and a plurality of output channels. The detector switches a disable signal to an enable signal according to a start pulse, wherein the source driver prepares to output display data according to the start pulse. The buffers are electrically connected to the detector. Furthermore, each of the buffers stops operating according to a disable signal and starts operating according to an enable signal. The output channels are electrically connected to output ends of the buffers, and the source driver transmits signals outputted by the buffers through the output channels.

In an embodiment of the present invention, the source driver sequentially receives an analog power voltage and a start pulse. Furthermore, the detector compares the analog power voltage with a threshold voltage. Whereby, when the analog power voltage is greater than threshold voltage, the detector generates a first control signal. Comparatively, when the analog power voltage is not greater than threshold voltage, the detector generates a second control signal.

In an embodiment of the present invention, the source driver further includes a plurality of reset units. The reset units are electrically connected between the output ends of the buffers and the output channels. Furthermore, the reset units conduct the output ends of the buffers to the output channels according to the first control signal. Then, the reset units respectively transmit a constant voltage to the output channels according to the second control signal.

The present invention provides a source driver, which includes a plurality of output channels, a plurality of buffers and a detector. The output ends of the buffers are electrically connected to the output channels. Furthermore, the detector detects a start pulse, and determines whether or not to enable the buffers according to a detection result, wherein the source driver prepares to output display data according to the start pulse.

In an embodiment of the present invention, when the start pulse is detected, the detector generates an enable signal to enable the buffers. When the start pulse is not detected, the detector generates a disable signal to disable the buffers.

Based on the above, the present invention controls the buffer in the source driver according to the start pulse. Here, as the start pulse is generated after the analog power voltage is stabilized, the buffer is enabled according to the start pulse, thus preventing the peak current generated by the source driver in the period when the analog power voltage continuously rises.

In order to make the aforementioned features and advantages of the present invention comprehensible, embodiments are described in detail below with reference to the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a time sequence diagram of a power-on sequence of a source driver.

FIG. 2 is a schematic circuit diagram of a source driver according to an embodiment of the present invention.

FIG. 3 is a schematic diagram of a buffer according to an embodiment of the present invention.

FIG. 4 is a schematic circuit diagram of a reset unit according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

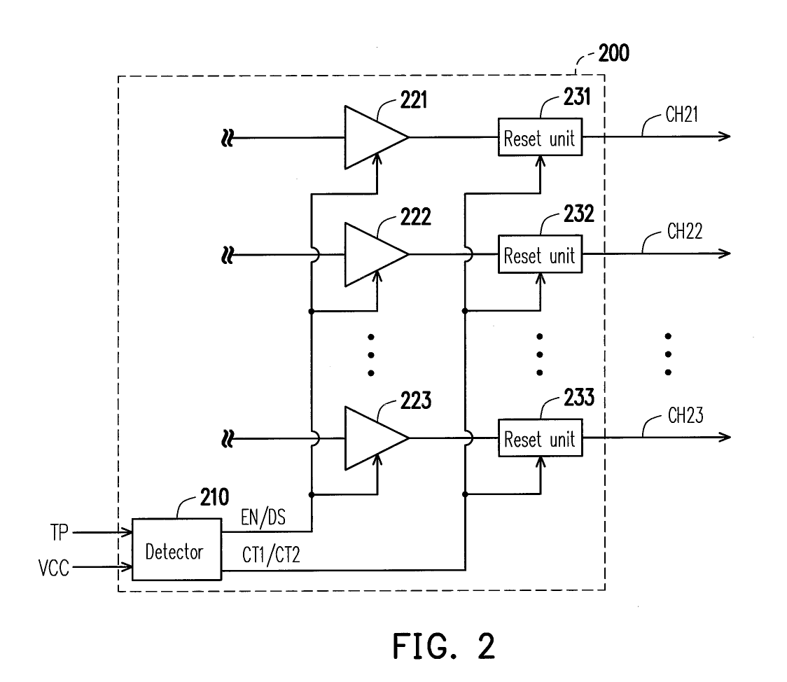

FIG. 2 is a schematic circuit diagram of a source driver according to an embodiment of the present invention. Referring to FIG. 2, a source driver 200 includes a detector 210, a plurality of buffers 221˜223, a plurality of reset units 231˜233 and a plurality of output channels CH21˜CH23. The reset units 231˜233 are electrically connected between output ends of the buffers 221˜223 and the output channels CH21˜CH23. That is, the output ends of the buffers 221˜223 are indirectly and electrically connected to the output channels CH21˜CH23 through the reset units 231˜233.

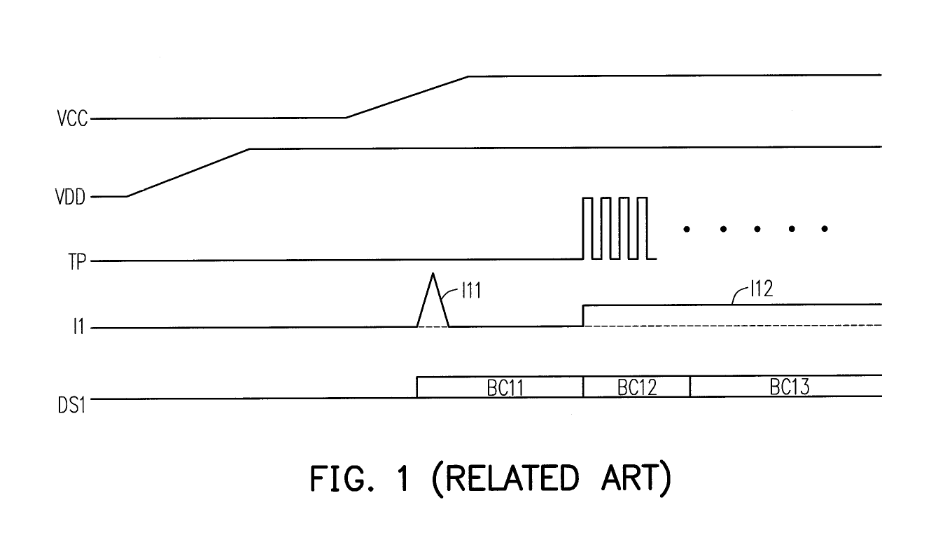

In view of operation, as shown in FIG. 1, the source driver 200 sequentially receives an analog power voltage VCC and a start pulse TP. Wherein, the source driver 200 prepares to output display data according to the start pulse TP, and the source driver 200 is operated under the analog power voltage VCC. Here, the detector 210 detects the start pulse TP, and determines whether or not to enable the buffers 221˜223 according to a detection result. When the start pulse TP is detected, the detector 210 generates an enable signal EN to enable the buffers 221˜223. Whereby, the buffers 221˜223 start operating normally and amplifies a received input signal. Furthermore, when the start pulse TP is not detected by the detector 210, the detector 210 generates a disable signal DS to disable the buffers 221˜223. Whereby, the buffers 221˜223 stop operating.

In other words, when the source driver 200 receives the start pulse TP, the detector 210 switches the disable signal DS to the enable signal EN, so that the buffers 221˜223 start operating normally. Comparatively, before receiving the start pulse TP, the detector 210 transmits the disable signal DS to the buffers 221˜223, and then all the buffers 221˜223 stay in a disable state. In this manner, in the period when the analog power voltage VCC continuously rises, the buffers 221˜223 stop operating to prevent the source driver 200 from generating a peak current.

On the other hand, the detector 210 compares the analog power voltage VCC with a threshold voltage. When the analog power voltage VCC is greater than the threshold voltage, the detector 210 generates a first control signal CT1. Now, the reset units 231˜233 conduct the output ends of the buffers 221˜223 to the output channels CH21˜CH23 according to the first control signal CT1. In this manner, the source driver 200 transmit signals outputted by the buffers 221˜223 through the output channels CH21˜CH23, thereby making a display device adopting the source driver 200 generate a corresponding display image.

Comparatively, when the analog power voltage VCC is not greater than the threshold voltage, the detector 210 generates a second control signal CT2. Now, the reset units 231˜233 transmit a constant voltage, such as a ground voltage, to the output channels CH21˜CH23 of the source driver 200 according to the second control signal CT2. In this manner, in the period when the analog power voltage VCC continuously rises, the display device adopting the source driver 200 will not generate a random noise, which further improves the display quality of the display device.

It should be noted that although the implementation of the source driver 200 is illustrated in the embodiment of FIG. 2, it should not be regarded as limitations to the present invention. Here, persons of ordinary skills in the art may optionally remove the reset units 231˜233 with reference to the embodiment. Whereby, the buffers 221˜223 may be directly and electrically connected to the output channels CH21˜CH23. Furthermore, as the detector 210 is not required to control the reset units 231˜233, the detector 210 will not compare the magnitude of the analog power voltage VCC.

In order that the persons of ordinary skill in the art further understands the embodiment of FIG. 2, the implementations of the buffer and the reset unit are illustrated in the following paragraphs.

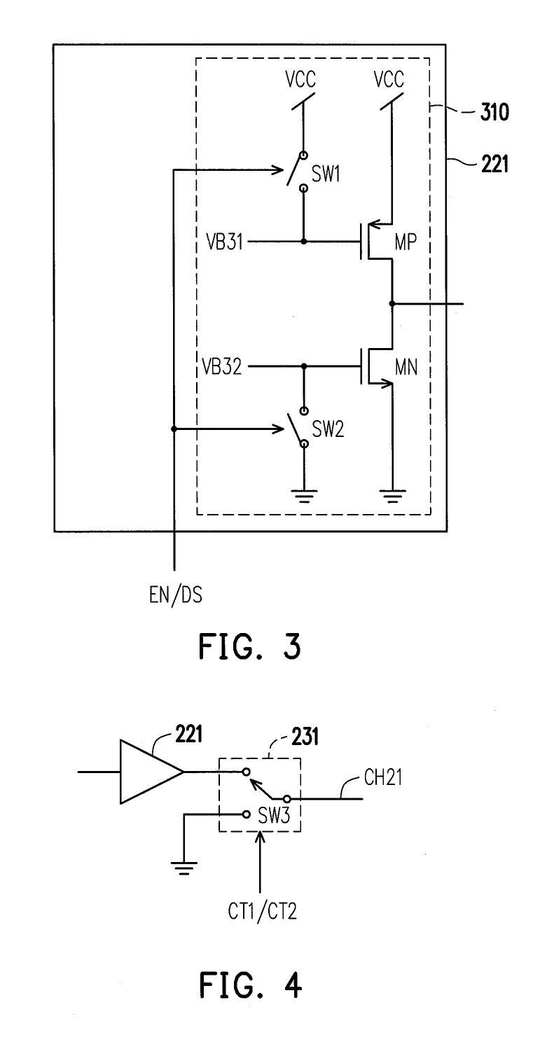

FIG. 3 is a schematic diagram of a buffer according to an embodiment of the present invention. Referring to FIG. 3, an output stage 310 of the buffer 221 includes a PMOS transistor MP, an NMOS transistor MN, a switch SW1 and a switch SW2. A source of the PMOS transistor MP receives the analog power voltage VCC and a drain of the PMOS transistor MP is electrically connected to the corresponding output channel CH21. A drain of the NMOS transistor MN is electrically connected to the drain of the PMOS transistor MP and a source of the NMOS transistor MN receives a ground voltage. A first end of the switch SW1 receives the analog power voltage VCC and a second end of the switch SW1 is electrically connected to a gate of the PMOS transistor MP. A first end of the switch SW2 receives the ground voltage and a second end of the switch SW2 is electrically connected to a gate of the NMOS transistor MN.

In view of operation, when the buffer 221 receives the enable signal EN from the detector 210, the switch SW1 and the switch SW2 disconnect the first ends and the second ends thereof according to the enable signal EN. Whereby, the gates of the PMOS transistor MP and the NMOS transistor MN are respectively biased at normal bias VB31 and VB32, and thus the buffer 221 operates normally. In contrast, when the buffer 221 receives the disable signal DS from the detector 210, the switch SW1 and the switch SW2 conduct the first ends and the second ends thereof according to the disable signal DS. Whereby, the gates of the PMOS transistor MP and the NMOS transistor MN are respectively biased at the analog power voltage VCC and the ground voltage, and thus the buffer 221 fails to operate normally.

FIG. 4 is a schematic circuit diagram of a reset unit according to an embodiment of the present invention. For the convenience of illustration, the buffer 221 and the output channel CH21 are indicated in FIG. 4. Referring to FIG. 4, the reset unit 231 includes a switch SW3. Furthermore, a first end of the switch SW3 is electrically connected to the corresponding buffer 221, a second end of the switch SW3 receives the constant voltage (for example, the ground voltage), and a third end of the switch SW3 is electrically connected to the corresponding output channel CH21.

In view of operation, when the reset unit 231 receives the first control signal CT1 from the detector 210, the switch SW3 conducts the first end to the third end thereof according to the first control signal CT1. Whereby, the output channel CH21 transmits the signal outputted by the buffer 221. Furthermore, when the reset unit 231 receives the second control signal CT2 from the detector 210, the switch SW3 conducts the second end to the third end thereof according to the second control signal CT2. Whereby, the reset unit 231 transmits the constant voltage to the output channel CH21.

In view of the above, the present invention controls the buffer in the source driver according to the start pulse. Here, as the start pulse is generated after stabilizing the analog power voltage, the buffer is enabled according to the start pulse, thus preventing the peak current generated by the source driver in the period when the analog power voltage continuously rises. Furthermore, the present invention further uses the detector to detect the magnitude of the analog power voltage, so as to suitably transmit the constant voltage to the output channel of the source driver, thereby preventing generating the random noise.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A source driver, comprising:
a detector, for switching a disable signal to an enable signal according to a start pulse, wherein the source driver prepares to output display data according to the start pulse;
a plurality of buffers, electrically connected to the detector, wherein each of the buffers stops operating according to the disable signal and starts operating according to the enable signal; and
a plurality of output channels, electrically connected to output ends of the buffers, wherein the source driver transmits signals outputted by the buffers through the output channels.

2. The source driver according to claim 1, wherein each of the buffers comprises:
a PMOS transistor, comprising a source receiving an analog power voltage and a drain electrically connected to the corresponding output channel;
an NMOS transistor, comprising a drain electrically connected to the drain of the PMOS transistor and a source receiving a ground voltage;
a first switch, comprising a first end receiving the analog power voltage and a second end electrically connected to a gate of the PMOS transistor; and
a second switch, comprising a first end receiving the ground voltage and a second end electrically connected to a gate of the NMOS transistor,
wherein the first switch and the second switch disconnect the first ends and the second ends thereof according to the enable signal and conduct the first ends and the second ends thereof according to the disable signal.

3. The source driver according to claim 1, wherein the source driver receives an analog power voltage and the start pulse sequentially, and the detector compares the analog power voltage with a threshold voltage so as to generate a first control signal when the analog power voltage is greater than the threshold voltage and generate a second control signal when the analog power voltage is not greater than the threshold voltage.

4. The source driver according to claim 3, further comprising:
a plurality of reset units, electrically connected between the output ends of the buffers and the output channels, wherein the reset units conduct the output ends of the buffers to the output channels according to the first control signal, and the reset units transmit a constant voltage to the output channels according to the second control signal.

5. The source driver according to claim 4, wherein each of the reset units comprises:
a third switch, comprising a first end electrically connected to the corresponding buffer, a second end receiving the constant voltage and a third end electrically connected to the corresponding output channel,
wherein the third switch conducts the first end to the third end thereof according to the first control signal and conducts the second end to the third end thereof according to the second control signal.

6. A source driver, comprising:
a plurality of output channels;
a plurality of buffers, wherein output ends of the buffers are electrically connected to the output channels; and
a detector, detecting a start pulse and determining whether or not to enable the buffers according to a detection result, wherein the source driver prepares to output display data according to the start pulse.

7. The source driver according to claim 6, wherein when the start pulse is detected by the detector, the detector generates an enable signal to enable the buffers, when the start pulse is not detected by the detector, the detector generates a disable signal to disable the buffers.

8. The source driver according to claim 7, wherein each of the buffers comprises:
a PMOS transistor, comprising a source receiving an analog power voltage and a drain electrically connected to the corresponding output channel;
an NMOS transistor, comprising a drain electrically connected to the drain of the PMOS transistor and a source receiving a ground voltage;
a first switch, comprising a first end receiving the analog power voltage and a second end electrically connected to a gate of the PMOS transistor; and
a second switch, comprising a first end receiving the ground voltage and a second end electrically connected to a gate of the NMOS transistor,
wherein the first switch and the second switch disconnect the first ends and the second ends thereof according to the enable signal, and conduct the first ends and the second ends thereof according to the disable signal.

9. The source driver according to claim 6, wherein the source driver receives an analog power voltage and the start pulse sequentially, and the detector compares the analog power voltage with a threshold voltage so as to generate a first control signal when the analog power voltage is greater than the threshold voltage and generate a second control signal when the analog power voltage is not greater than the threshold voltage.

10. The source driver according to claim 9, further comprising:
a plurality of reset units, electrically connected between the output ends of the buffers and the output channels, wherein the reset units conduct the output ends of the buffers to the output channels according to the first control signal, and the reset units transmit a constant voltage to the output channels according to the second control signal.

11. The source driver according to claim 10, wherein each of the reset units comprises:
a third switch, comprising a first end electrically connected to the corresponding buffer, a second end receiving the constant voltage and a third end electrically connected to the corresponding output channel,
wherein the third switch conducts the first end to the third end thereof according to the first control signal and conducts the second end to the third end thereof according to the second control signal.
